(19) United States
(12) Patent Application Publication
(10) Pub. No.: US 2019/0275549 A1
(43) Pub. Date: Sep. 12, 2019

(54) Apparatus for Dispensing Liquid Which Enables Use of a Conventional Spraying Device in Multiple Directions

(71) Applicants: Jonathan LeClere, New Market, MD (US); John Gillispie, Urbana, MD (US)

(72) Inventors: Jonathan LeClere, New Market, MD (US); John Gillispie, Urbana, MD (US)

(21) Appl. No.: 16/294,357

(22) Filed: Mar. 6, 2019

Related U.S. Application Data
(60) Provisional application No. 62/640,294, filed on Mar. 8, 2018.

(51) Int. Cl. B05B 15/30

(52) U.S. Cl. CPC B05B 15/30

(57) ABSTRACT

Embodiments of the present invention provide an apparatus comprising a dip tube which is typically connected to a standard spray trigger, where the dip tube has one or more bulging-out sections provided along shaft of the dip tube. The apparatus can be used with any conventionally available spraying device, such as a spray bottle. The apparatus is inserted in the spraying device filled with a desired liquid. The bulging-out sections contain a portion of total amount of the liquid contained in the spraying device, and allow for extended spraying in multi-directional positions, including upside down, in which the dip tube may or may not be fully submerged into the liquid. In such positions, a spraying action draws out liquid contained in the bulging-out sections and sprays on a desired surface. Therefore, the present invention allows for effective spraying even in multi-directional positions of the spraying device, without compromising with regular spraying process.

### CROSS-REFERENCE TO RELATED APPLICATIONS

This application claims the benefit of U.S. Provisional Patent Application No. 62/640,294, filed Mar. 8, 2018.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF INVENTION

The present invention generally relates to a portable liquid spray device. More particularly, the present invention relates to a portable spray device with triggers or pump operated bottles for delivering liquid such as cleaning products, perfumes, dyes, medications, etc.

### BACKGROUND OF INVENTION

Conventional spraying devices generally have a container filled with liquid, and a dip tube that is connected to a trigger; the dip tube goes into the bottle for drawing the liquid out, and spraying using the trigger. The dip tube is usually a hollow tube which is straight and uniform throughout its shape. It draws liquid out from the bottle, when the trigger is pressed by a user.

While using such spraying devices, the user may need to spray the liquid in multiple directions, which requires the spray device or the spray bottle to be tilted or positioned in multiple angles. For example, the bottle may need to be turned upside-down to spray a desired surface, or may need to be tilted at a certain angle for an effective spray. During such tilting or positioning of the spray bottle, the liquid contained inside also flows in the same direction. Consequently, the dip tube may not be able to draw out the liquid, because the bottom opening of the conventional hollow dip tube would no longer be submerged in the liquid, and the dip tube itself can only hold a minimal amount of or liquid. Therefore, an effective spraying may not be achieved.

Thus, there exists a need for a spraying device which is able to spray effectively when the spray device is turned in multiple directions. More particularly, there exists a need of a spraying mechanism that can be used with conventionally available spraying devices, allowing for multi-directional spraying.

### SUMMARY OF INVENTION

Hence, the present invention provides an apparatus as part of a spraying mechanism to overcome the shortcomings of conventional spray bottles. The present invention provides an additional reservoir in the dip tube, for increasing the amount of liquid available to the spraying device and allowing it to spray more liquid, in multiple directions effectively without significantly compromising regular spraying. Further, the apparatus with the spraying mechanism comprises a dip tube that goes into a conventionally available trigger spray, pump, or other style dispenser bottle, where the dip tube does not have a continuous, straight and uniform shape, rather includes one or more bulging-out sections or blown out sections incorporated between lengths of the dip tube. The bulging-out section(s) have a diameter larger than the diameter of the rest of dip tube, which therefore allows more liquid to collect inside the bulging-out sections.

An embodiment of the present invention provides the dip tube to include multiple bulging-out sections along the length of the dip tube. For an example two or more smaller bulging-out sections can increase the amount of efficiency of the spraying, depending on quality and strength of suction, to draw the liquid to the top of the dip tube, while still allowing liquid to pool in these multiple bulbs, to allow for the multi-directional spraying.

In an embodiment, the apparatus comprises of the dip tube along with a trigger attached to the top of the dip tube, which when pressed sucks the liquid out of the spraying container. The trigger is configured to attach to the spraying device.

In an embodiment, the dip tube has bulging-out sections in shape of a bulb-like section.

In an embodiment, the bulging-out section has the shape of a sphere along the length of the dip tube.

In another embodiment, the bulging-out section has an elliptical shape.

An embodiment of the present invention provides an apparatus assisting in dispensing, such as spraying, of a fluid out from a container (for example a spray bottle), the apparatus comprising of a dip tube with the bulging-out section(s) provided along a shaft of the dip tube, the bulging-out section(s) acts like a reservoir to store at least a portion of a total quantity of fluid contained in the container, the portion of the fluid that is stored in the bulging-out section(s) has greater volume of the fluid than volume of the fluid contained in the dip tube, individually; and wherein, when the dip tube is inserted in the container to assist in dispensing out of the fluid from the container, the dip tube allows the container to be used in multi-directional positions for multi-directional dispensing, such that when a bottom opening of the dip tube is either partially submerged or not submerged into the fluid during the multi-directional positions of the container, the bulging-out section(s) of the dip tube retains greater volume of the fluid than the volume of the fluid retaining in the dip tube, individually, while using the container for multi-directional dispensing of the fluid.

An embodiment of the present invention provides the bulging-out section is positioned anywhere on or along the shaft of the dip tube, the bulging-out section has any possible variety of shapes or sizes, width or height, or wall thickness or material, depending on shapes or sizes, width or height, or wall thickness or material of the dip tube and the container.

An embodiment of the present invention provides that the bulging-out section(s) has a diameter larger than diameter of the dip tube, and the bulging-out section(s) is provided along a section of the shaft of the dip tube, including upper section, lower section and middle section.

The bulging-out section has all possible measurements with any size or proportional size, from zero to infinity, the possible measurements being applicable to any size or shape of the bulging-out section of the dip tube.

Another embodiment of the present invention provides the dip tube has multiple bulging-out sections provided along the shaft of the dip tube, and during a spraying action, at least one of the multiple bulging-out sections retains a portion of the total quantity of liquid contained in the spraying container.

An objective of the present invention is to allow a conventional container to be used at multi-directional positions, including any angle or in an upside-down position, and the conventional spraying device to be used in multi-directional positions with little to no effect on regular spraying actions from the conventional spraying device.

An objective of the present invention is to dispense out any fluid from the container, such as liquid, semi viscous-liquid, or gas, able to be dispensed out of the container.

The foregoing and other objects, features and advantages of the invention will be apparent from the following more particular descriptions of exemplary embodiments of the invention.

### BRIEF DESCRIPTION OF DRAWINGS

FIG. 1 illustrates an exemplary environment showing a dip tube of a spraying mechanism with one bulging-out section provided along length of the dip tube, in accordance with an embodiment of the present invention;

FIG. 2 illustrates an exemplary environment showing the dip tube, with one bulging-out section, attached with a trigger and the dip tube inserted into a spraying device, in accordance with an embodiment of the present invention;

FIG. 3 illustrates an exemplary environment showing a dip tube, with two bulging-out sections, attached with a trigger and the dip tube inserted into a spraying device, in accordance with an embodiment of the present invention;

### DETAILED DESCRIPTION

This patent describes the subject matter for patenting with specificity to meet statutory requirements. However, the description itself is not intended to limit the scope of this patent. The principles described herein may be embodied in many different forms.

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

The present invention provides an apparatus comprising a dip tube where the dip tube is provided with one or more bulging-out sections along shaft of the dip tube. The apparatus is for assisting dispensing out, or evacuating out a fluid from a container, and the apparatus can be used with any conventional container, such as a conventional spray bottle. The bulging-out sections have diameter larger than the diameter of the dip tube. The dip tube is a hollow cylindrical tube that goes inside the container, such as a standard conventional spraying device containing fluid, such as liquid and sucks or draws the fluid into it as and when a trigger is pressed by a user of the spraying device. The shaft of the dip tube includes length of the dip tube. A trigger is removably attached to the opening of the spraying device, closing the device and not allowing the liquid to spill out from the spraying device.

The apparatus with the spraying mechanism can be easily used with any portable or non-portable conventionally available spraying devices. The bulging-out section is small enough to fit into the conventionally available spraying device, but large enough to allow a quantity of liquid to be collected into it during a spraying process.

When the apparatus comprising the dip tube with the bulging-out section(s) is inserted into the spraying device containing a quantity of liquid, a portion from the quantity of the liquid is collected into the bulging-out section(s), depending on design and dimensions of the bulging-out section(s). Because of the presence of the bulging-out section(s) along the shaft of the dip tube, when the spraying device is turned at various angles, including upside down, spraying can effectively continue at such varied angles, from the liquid that is collected and retained in the bulging-out section(s). Additionally, regular spraying is not effected or minimally effected when the upside-down or an angled spraying is complete.

In an embodiment, the dip tube may include multiple bulging-out sections, for example two or more, along the shaft. Two or more smaller bulging-out sections can increase the amount of efficiency of the trigger, depending on quality and strength of suction, to draw the liquid to the top of the dip tube, while still allowing liquid to pool in these multiple bulging-out sections, to allow for the multi-directional spraying.

It may be apparent to a person skilled in the art, that the dip tube may have any number of bulging-out sections along the shaft, depending on the dimensions of the dip tube and the bulging-out sections and requirements of the spraying process, without deviating from the meaning and scope of the present invention.

It may be apparent to a person skilled in the art, that the dip tube may have the bulging-out sections of various shapes and sizes, depending on the dimensions of the dip tube and the bulging-out sections and requirements of the spraying process, without deviating from the meaning and scope of the present invention. For an example, in an embodiment, the bulging-out sections may have bulb-like shape. In another embodiment, the bulging-out sections may have spherical or round shape. In yet another embodiment, the bulging-out sections may have elliptical shape. In yet another embodiment, the bulging-out sections may have hexagonal shape

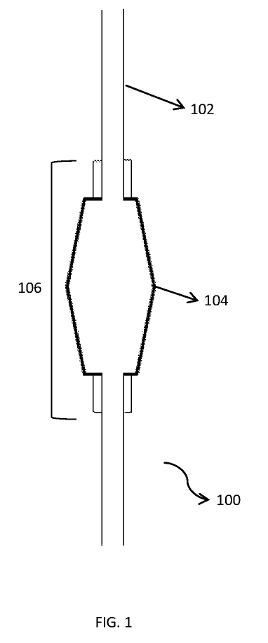

FIG. 1 illustrates an exemplary environment showing the dip tube, in accordance with an embodiment of the present invention. The embodiment 100 includes the dip tube 102 provided with a bulging-out section 104 along shaft of the dip tube 102. The dip tube 102 is a hollow, long cylindrical tube. The bulging-out section 104 has larger diameter than diameter of the dip tube 102. The shaft of the dip tube 102 includes the length of the dip tube 102. The bulging-out section 104 can be effectively provided at any position along the shaft of the dip tube 102. For example, the bulging-out section 104 may be provided in middle of the shaft of the dip tube 102. In another exemplary embodiment, the bulging-out section 104 may be provided in upper section of the shaft of the dip tube 102. In yet another exemplary embodiment, the bulging-out section 104 may be provided in lower section of the shaft of the dip tube 102.

For an exemplary spraying process, the dip tube 102 attached to a trigger (not shown in FIG. 1), is inserted into a conventionally available spraying device, for example a house floor cleaner spray bottle, containing a quantity of liquid, which is the floor cleanser in this case. As and when the dip tube 102 is inserted into a standard spraying device, a portion of the quantity of the liquid contained in the spraying device gets collected inside the bulging-out section 104. This portion of the quantity of the liquid that is collected in the bulging-out section 104 is greater in volume than the volume of the liquid collected in the dip tube 102 alone. During the spraying process, multi-directional spraying may also be needed, which further requires the spraying device to be tilted in various angles in multi-directions. While tilting the spraying device, bottom opening of the dip-tube 104 may or may not be fully submerged into the liquid, which affects the spraying process. However, the bulging-out section 104 retains the portion of the liquid in it, whether the spraying device is tilted or not. Therefore, while the spraying device is tilted and used, each spray from the spraying device draws out liquid from the portion of the liquid contained in the bulging-out section 104. Consequently, a full spray is achieved even when the spraying device is tilted in various angles in multi-directions or even turned upside down.

A portion of the liquid contained in bulging-out section 104 depends on the dimensions of the bulging-out section 104. An exemplary dimension of the dip tube 102 with the bulging-out section may include and is not limited to length of the dip tube 102 is 240 mm, diameter of the dip tube 102 is 3.6 mm, length of the bulging-out section 104 along the shaft of the dip tube 102 is 56 mm, diameter of the bulging-out section 104 is 20 mm, and an effective length 106 around the bulging-out section 104 along the shaft of the dip tube 102 is 70.6 mm. The effective length of the bulging-out section 104 is such that the bulging-out section 104 must clear the size of the standard spraying device where the trigger is screwed on, and the length of the bulging-out section 104 along the dip tube 102 should be such that to make it big enough to hold liquid, but not too big so that bulging-out section 104 does not spray out normally. In another embodiment, the diameter of the bulging-out section 104 may be within the range of 15-20 mm.

Desired size of the bulging-out section 104 can vary from none to infinity, however, a specific bulging-out section 104 capacity should be constructed taking into consideration the amount of liquid that the strength of the trigger can allow to be evacuated in a single spray, coupled with how many sprays a user would want to be able to make when the spraying device is sprayed out at an angle or upside down.

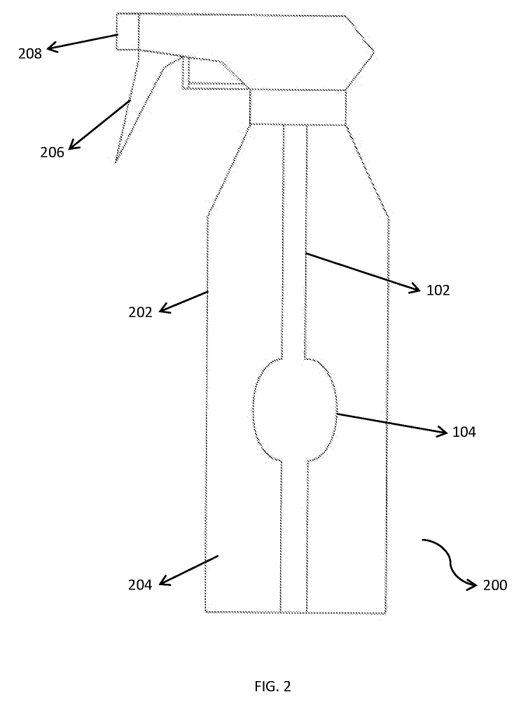

FIG. 2 illustrates an exemplary environment showing the dip tube, with one bulging-out section, and the dip tube inserted into a standard conventional spraying device, in accordance with an embodiment of the present invention. The embodiment 200 includes a spraying device 202 with an inner capacity 204 containing a desired liquid. The dip tube 102, with one bulging-out section 104 provided along the shaft of the dip tube 102. The dip tube is attached to a trigger 206. In an embodiment, the dip tube 102 may be removably attached to the trigger 206. The trigger 206 when pressed by a user of the spraying device 202, allows the liquid to be drawn out of the inner capacity 204, via the dip tube 102 and the bulging-out section 104, and sprayed out from a spraying outlet 208.

A portion from quantity of the liquid contained in the capacity 204 of the spraying device 202 is collected inside the bulging-out section 104. The portion of the liquid contained in the bulging-out section 104 is not affected by tilting of the spraying device 202 in any angle including upside down. The portion of the liquid in the bulging-out section 104 is greater in volume than the volume of the liquid contained in the dip tube 102 alone. During tilting of the spraying device 202, the bulging-out section 104 will still be filled with the portion of the liquid, unlike the bottom of the dip tube 102 which may or may not be fully submerged in the liquid contained in the capacity 204 of the spraying device 202. In an embodiment, during a spraying action, at least one of the multiple bulging-out sections retains a portion of the total quantity of liquid contained in the spraying device.

In an exemplary embodiment, the diameter of the bulging-out section 104 is larger than the diameter of the dip tube 102, for example the diameter of the bulging-out section 104 may be ¾^{th} of the diameter of upper opening of the spraying device 202, while the diameter of the dip tube 102 may be ⅛^{th} of the diameter of the upper opening of the spraying device 202.

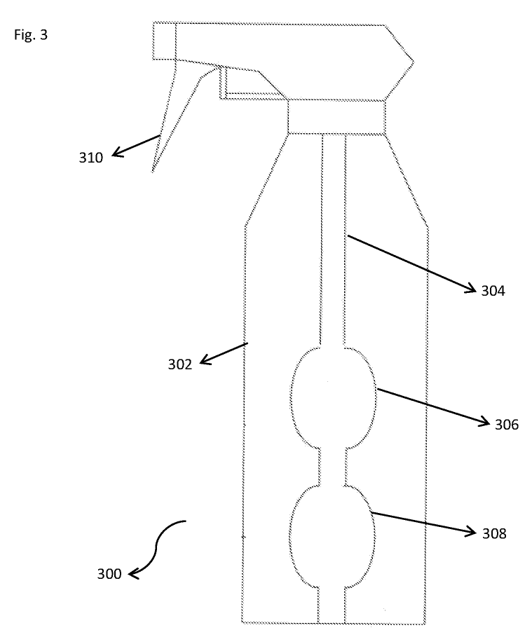

FIG. 3 illustrates an exemplary environment showing a dip tube, with two bulging-out sections, and the dip tube inserted into a standard conventional spraying device, in accordance with an embodiment of the present invention. The embodiment 300 includes a spraying device 302 containing a desired liquid. The dip tube 304, with two bulging-out sections 306 and 308 provided at a distance along the shaft of the dip tube 102, is attached to a trigger 310. This distance may be equal between the bulging-out sections, or may be different, in case of more than two bulging-out sections.

The two bulging-out sections 306 and 308 may be placed at any two positions along the shaft of the dip tube 304. For example including and not limited to, upper and lower; upper and middle, middle and lower. It may be apparent to a person skilled in the art that the two bulging-out sections 306 and 308 may be placed anywhere along the shaft of the dip tube 304, for carrying out effective spraying, depending on various factors including such as not limited to the dimensions of the bulging-out sections 306 and 308, dimensions of the dip tube 304, dimensions of the spraying device 302, requirements of the spraying process, without deviating from the meaning and scope of the present invention.

Further, the two bulging-out sections 306 and 308 may have same or different shapes and dimensions depending on various factors such as requirements of the spraying process, without deviating from the meaning and scope of the present invention.

It may be apparent to a person skilled in the art that the dip tube may have more than two bulging-out sections placed anywhere along the shaft of the dip tube, for carrying out effective spraying, where the multiple bulging-out sections may have same or different shapes and dimensions, depending on various factors including such as not limited to the dimensions of the bulging-out sections 306 and 308, dimensions of the dip tube 304, dimensions of the spraying device 302, requirements of the spraying process, without deviating from the meaning and scope of the present invention.

Advantageously, the present invention provides an apparatus comprising an innovative dip tube, where the dip tube is provided with one or more bulging-out sections present along the shaft of the dip tube. The apparatus can be effectively used with any conventionally available spraying device. The bulging-out section(s) contains a portion from total quantity of liquid contained in the spraying device, which is greater in volume than the volume of liquid contained in the dip tube alone. The spraying device with the dip tube of the present invention can be effectively used for multi-directional spraying, with tilting in various angles including upside down. This is because, even when the device is tilted in any angle, the bulging-out section will still be filled with the portion of the liquid, which can be drawn out and sprayed while the device is tilted in an angle.

Additionally, regular spraying is not affected or minimally affected when the upside-down or an angled spraying is complete, so there is little or no break in the traditional use, or the modified use provided by the spraying mechanism of present invention.

The apparatus, with the bulging-out section in the dip tube, allows for multiple-directional spraying, and can be used in bottles filled with indoor or outdoor liquids; for household cleaners, such as for around bathtubs, showers, sinks, or inside and outside commodes; for insecticides, such as for ants or bees in hard-to-reach places; for the delivery of skin-surface sprayed medicines, especially on the lower extremities, where it is otherwise difficult to self-administer, for perfumes or fragrances; for automobiles, such as hard-to-reach places inside an automobile engine or the interior for cleaning; and for any other spray or pump bottle of any size or application. The size and depth of the bulging-out section to simply be adjusted to accommodate desired quantity and number of sprays in the trigger or pump bottles.

The device can be manufactured using standard plastic molding device, most preferably a combination of injection molding (for the standard part of the trigger) and injection and/or blow molding for the dip tube with the bulging-out section. The dip tube with at least one bulging-out section can be manufactured as one part, with no seams or separation between sections of dip tube and bulb(s), or as separate pieces or sections that fit together and then are glued, heated, or in any other way affixed together to form the dip tube with bulging-out section.

While the foregoing written description of the invention and corresponding drawing enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. An apparatus assisting in dispensing, such as spraying, of a fluid out from a container (for example a spraying device), the apparatus comprising of:
a dip tube with at least one bulging-out section provided along a shaft of the dip tube, where the bulging-out section(s) acts like a reservoir to store a portion of a total quantity of fluid contained in the container, the portion of the fluid that is stored in the bulging-out section(s) has greater volume of the fluid than volume of the fluid contained in a dip tube without a bulging-out section, individually; and
wherein, when the dip tube is inserted in the container to assist in dispensing the fluid from the container, the dip tube with a bulb allows the container to be used in multi-directional positions for multi-directional dispensing, such that when the bottom opening of the dip tube is either partially submerged or not submerged into the fluid during the multi-directional positions of the container, bulging-out section(s) of the dip tube retains and dispenses a greater volume of the fluid than the available in a standard dip tube, while using the container for multi-directional dispensing of the fluid.

2. The apparatus of claim 1, wherein the bulging-out section is positioned anywhere on or along the shaft of the dip tube, the bulging-out section has any possible variety of shapes or sizes, width or height, or wall thickness or material, depending on shapes or sizes, width or height, or wall thickness or material of the dip tube and the container.

3. The apparatus of claim 2, wherein the bulging-out section(s) has a diameter larger than diameter of the dip tube, and bulging-out section(s) is provided along a section of the shaft of the dip tube, including upper section, lower section and middle section.

4. The apparatus of claim 2, wherein length of the dip tube is 240 mm, diameter of the dip tube is 3.6 mm, length of the bulging-out section(s) along the shaft of the dip tube is 56 mm, the diameter of bulging-out section is within a range of 15 mm-20 mm.

5. The apparatus of claim 2, wherein the bulging-out section(s) has all possible measurements with any size or proportional size, from zero to infinity, the possible measurements being applicable to any size or shape of the bulging-out section of the dip tube.

6. The apparatus of claim 1, wherein at least one bulging-out section has a shape including at least one bulb-like shape, spherical shape, round shape, elliptical shape, or hexagonal, or any other conceivable shape.

7. The apparatus of claim 1, wherein the dip tube has multiple bulging-out sections provided along the shaft of the dip tube, and during a spraying action, at least one of the multiple bulging-out sections retains a portion of the total quantity of liquid contained in the spraying device.

8. The apparatus of claim 2, wherein the multiple bulging-out sections have different dimensions, including shape and size.

9. The apparatus of claim 2, wherein the multiple bulging-out sections are positioned at a distance from each other; positioned either equidistantly or at different distances from each other.

10. The apparatus of claim 1 further allows the spraying device to be used at any angle or in an upside-down position.

11. The apparatus of claims 1 and 7, wherein the dip tube, with one or more bulging-out sections, is manufactured in either one of following ways:
as one continuous part, with no seams or separation between sections of the dip tube and the bulging-out section(s); or
as separate pieces or sections, where the pieces or the sections correspond to the dip tube and the bulging-out sections, and the pieces or the sections fit together to form the apparatus of claims 1 and 7.

12. The apparatus of claim 11, wherein the separate pieces or the sections corresponding to the dip tube and the bulging-out sections are fit together using any one of fitting mechanism, such as using glue, heating the separate pieces or the sections together and then fitting, or in any other conventionally available way.

13. The apparatus of claim 1 with the spraying mechanism enables the conventional spraying device to be used in multi-directional positions with little to no effect on regular spraying actions from the spraying device.

14. The apparatus of claim 1 allows for multiple-directional dispensing of fluid from the container, the fluid in the containers being indoor or outdoor liquids; the apparatus being used for household cleaners, including around bathtubs, showers, sinks, or inside and outside commodes; the apparatus being used for insecticides, including for ants or bees in hard-to-reach places; the apparatus being used for delivery of skin-surface sprayed medicines, especially on the lower extremities, where it is otherwise difficult to self-administer, the apparatus being used for perfumes or fragrances; the apparatus being used for automobiles, including hard-to-reach places inside an automobile engine or interior for cleaning; and the apparatus being used for any other spray or pump bottle of any size or application.

15. The apparatus of claim 1, wherein size and depth of the bulging-out section(s) being adjusted to accommodate a desired quantity of the fluid and number of dispensing actions from the container.
